(19) United States
(12) Patent Application Publication
(10) Pub. No.: US 2026/0308947 A1
(43) Pub. Date: Oct. 8, 2026

(54) MOTOR VEHICLE LOCK, IN PARTICULAR MOTOR VEHICLE DOOR LOCK

(71) Applicant: Kiekert Aktiengesellschaft, Heiligenhaus (DE)

(72) Inventors: Armin HANDKE, Duisburg (DE); Carsten FUCHS, Essen (DE); Thorsten BENDEL, Oberhausen (DE)

(73) Assignee: Kiekert Aktiengesellschaft, Heiligenhaus (DE)

(21) Appl. No.: 18/880,688

(22) PCT Filed: Jun. 1, 2023
(86) PCT No.: PCT/DE2023/100413

§ 371 Date: Jan. 2, 2025

(30) Foreign Application Priority Data
Jul. 8, 2022 (DE) 10 2022 117 128.0

(51) Int. Cl. E05B 79/08; E05B 77/06; E05B 81/06; E05B 81/14; E05B 85/02

(52) U.S. Cl. CPC E05B 79/08; E05B 77/06; E05B 81/06; E05B 81/14; E05B 85/02

(57) ABSTRACT

The invention relates to a motor vehicle lock, in particular a motor vehicle door lock, which is equipped with a locking mechanism (1, 2) consisting substantially of a rotary latch (1) and a pawl (2). Furthermore, an actuating lever chain (9, 10, 11, 12) is provided for the locking mechanism (1, 2). In addition, at least one functional unit (14, 15, 16; 8, 13) driven by an electric motor (7, 13) is provided, said functional unit being optionally and interchangeably accommodated in an associated lock housing (3, 4). According to the invention, the functional unit (14, 15, 16; 8, 13) is designed as an opening drive (14, 15, 16) and/or active mass inertia element (8, 13).

The invention relates to a motor vehicle lock, in particular a motor vehicle door lock, having a locking mechanism consisting substantially of a rotary latch and a pawl, furthermore having an actuating lever chain for the locking mechanism, and having at least one functional unit driven by an electric motor, which unit is optionally and interchangeably accommodated in an associated lock housing.

Motor vehicle locks and in particular motor vehicle door locks are characterized by increasing complexity. This can be attributed to the fact that currently not only electromotive actuations are used in connection with the implementation of a central locking system or for electrical opening. Rather, such electromotive drives are increasingly also used in conjunction with a safety unit, for example a child safety lock unit, an anti-theft device, etc. Mass inertia elements also have such an electromotive drive, with the help of which, for example, a movement of the mass inertia element can be blocked. This is, for example, the subject of DE 10 2020 102 084 A1 and is due to the goal of improving safety overall.

In practice, the increasing variety of motor vehicle locks and in particular motor vehicle door locks described above is also met with a likewise growing number of variants of motor vehicles. This ultimately results in an exponentially or at least disproportionately increasing variety of motor vehicle locks and in particular motor vehicle door locks, depending on which vehicle type is to be equipped and which comfort or security level is to be implemented. In practice, this leads to increased production costs because the lock housing typically has to be adapted to the functional units to be accommodated inside.

According to WO 2016/078638A1, there are already approaches in the prior art to replace individual components and thus reduce the design effort. Here, the design is such that the drive with the electric motor works optionally on the locking mechanism and/or a locking element. The interaction takes place via at least one interchangeable intermediate element. Depending on the desired functionality, the intermediate element is a locking intermediate element, an opening intermediate element or a closing intermediate element.

In the generic prior art according to WO 2014/032640A1, the overall approach is that a functional unit described therein, in the form of a safety unit which is driven by an electric motor, is designed as a retrofit module that can be connected as required to a base module that largely comprises the locking mechanism, the actuating lever chain and a locking unit. For this purpose, the retrofit module has a retrofit module housing, which is designed to be capable of being mounted onto an associated base module housing. Both housings are equipped with corresponding centering devices for that purpose. This solves the overall problem of providing different equipment variants of the relevant motor vehicle lock depending on actual requirements while realizing significant cost advantages. For this purpose, the known motor vehicle lock is equipped, or not, with the safety unit or the associated retrofit module.

The safety unit is typically an anti-theft device, which generally prevents a motor vehicle door equipped with the corresponding motor vehicle lock from being opened from inside in an unauthorized manner after a window has been damaged or destroyed. Such an anti-theft device may also be dispensed with.

The prior art has basically worked well because the base module implemented at this point can be, or not, equipped with the retrofit module or the safety unit, as required. This allows a customer to individually opt for the motor vehicle lock or motor vehicle door lock by retrofitting the safety unit. This has proven to be fundamentally successful.

In addition to the safety unit in the generic prior art according to WO 2014/032 640A1, there are now further requirements for possible retrofitting and in particular for working on one and the same production line. This often requires the optional installation of several functional units or just one functional unit or no functional unit in the lock housing as well as the adaptation of the actuating lever chain thereto. There are currently no convincing practical proposals in this respect.

The invention is based on the technical problem of further developing such a motor vehicle lock and in particular a motor vehicle door lock such that the variation options are increased compared to the previous prior art and that there is the possibility of factory equipment in a production line.

To solve this technical problem, the invention proposes that, in a generic motor vehicle lock and in particular a motor vehicle door lock, the functional unit be designed as an opening drive and/or active mass inertia element. In this context, the term element should not be understood exclusively as a single part (element), but can also be a functional unit or a module having the function of a mass inertia lock/crash lock. According to the invention, it is thus particularly advantageous that the functional unit can represent electrical opening, a mass inertia locking function or both. The term mass inertia locking function can be understood in particular as at least one function of the active mass inertia element (unit). This may at least involve engaging or disengaging a coupling element or blocking element. Alternatively or additionally, a TCR function can also be achieved.

It may be advantageous that the opening drive, in particular the electric motor of the opening drive, allows for the electrical opening of the locking mechanism and/or a TCR function (see definition below). Furthermore, it is conceivable for the drive unit, in particular the electric motor, to allow for further lock functions such as anti-theft protection and/or a child safety lock and/or a central locking system. In order for the drive unit, in particular the electric motor, to be able to fulfill the corresponding functions listed, the lock, in particular the lock housing, is designed such that only different gears and/or levers have to be used. Alternatively, another additional motor can be used. Accordingly, one electric motor can be used for the opening function and one or more additional motors for the other functions.

Furthermore, it is advantageous to proceed such that the actuating lever chain is optionally designed as an internal actuating lever chain, an external actuating lever chain or a combined internal/external actuating lever chain. In this context, at least the external actuating lever chain is designed to be modular and is optionally accommodated in the lock housing or not.

First of all, this measure of the invention significantly increases the number of conceivable variations compared to the previous prior art. For, in contrast to the generic teaching according to WO 2014/032640A1, the question is not (any longer) whether or not to take the safety unit into account in terms of a retrofit module. Rather, the invention is based on the optional interchangeability of the opening drive, the active mass inertia element, both of the functional units mentioned or neither of these two functional units. In conjunction with the design of the actuating lever chain optionally as an internal actuating lever chain, external actuating lever chain or combined internal/external actuating lever chain, this already results in 12 different variation options (four variants for the functional unit and three variants of the actuating lever chain). These variation options are then increased to a total of 24 variants if an external actuation is additionally used or if an external actuation is not used for the opening drive. In the simplest case, this external actuation is a sensor assigned to an external door handle, with the help of which the external actuation of the external door handle is queried and reported to a control unit, which then in turn energizes the electric motor as a component of the opening drive in order to be able to open the locking mechanism and thus an associated motor vehicle door.

All of these variants, the number of which can basically be increased even more, can be realized and implemented already during production and lock housings can be realized and implemented already at the factory. For this purpose, the housing or lock housing that accommodates the entire motor vehicle lock or motor vehicle door lock is advantageously equipped with stops, bearing points, receptacles, etc. for all variants. In this context, it has proven to be particularly advantageous if the lock housing is designed as a plastic injection-molded part and is therefore made by plastic injection molding. This allows the stops, bearing points and receptacles to be manufactured in one piece with the lock housing, and in one go. Moreover, the stops, bearing points, receptacles, etc. can be easily and automatically integrated into the lock housing production process. Also, this makes it possible to design the lock housing such that it is routinely equipped with the relevant stops, bearing points, receptacles, etc. for all variants, so that ultimately there is only one variant for the lock housing which is equipped with the elements of the motor vehicle lock during the production process. This simplifies storage and makes production easier.

In fact, the stops can be stops for the locking mechanism, individual levers of the actuating lever chain or even stops for the one or more electric motors. In this context, for example bearing pins molded onto the lock housing are used as bearing points, which can be used to support individual levers of the actuating lever chain. The bearing points can basically also be bearing pins for the rotary latch and the pawl, which are typically defined in a metal lock case as another component of the lock housing in addition to a plastic cover.

The previously mentioned receptacles provided in the lock housing may serve for the placement and alignment of the respective electric motor or also of drive wheels as components of a gear connected downstream of the respective electric motor. In any case, all of these stops, bearing points, receptacles, etc. can be implemented in the lock housing, for all variants. In case of simply constructed variants, this then results in individual stops, bearing points or receptacles not being used or needed. However, this is acceptable in favor of a standardized manufacture of the lock housing, especially since the cover as a component of the lock housing is a plastic injection-molded part that is inexpensive to produce. Either way, this results in particular simplifications in manufacture because one and the same lock housing is used for the different variants and regardless of the respective equipment of the motor vehicle lock. These are the main advantages.

To implement this in detail, the functional unit can be equipped with its own functional housing. Said functional housing is detachably accommodated in the lock housing as an interchangeable insert. As a result, the functional housing can function and be designed, for example, to accommodate the opening drive, alternatively to accommodate the active mass inertia element or to accommodate both the functional unit and the active mass inertia element. In principle, the relevant functional unit and thus the interchangeable insert do not need to be mounted in the lock housing at all if a very simply constructed motor vehicle lock without an opening drive and active mass inertia element is to be realized.

The functional housing is, in turn, advantageously designed as a plastic injection-molded part. For this purpose, the functional housing, similar to the lock housing, has stops, bearing points, receptacles, etc. for the one or more functional units accommodated therein. For example, the one or more receptacles can each be used for the electric motor as a component of the opening drive or of the active mass inertia element. By means of the bearing point, for example a worm gear as part of the opening drive can be supported inside the functional housing. Associated stops ensure that, in the example case, the opening drive can be moved only within certain limits.

To couple the functional housing to the lock housing, the functional housing can be latched, clipped or otherwise detachably connected in the lock housing. Of course, a screw connection between the functional housing and the lock housing is also conceivable. It is basically also possible to work with several functional housings inside the lock housing, for example with a functional housing that accommodates the opening drive and with a second functional housing for the active mass inertia element.

The active mass inertia element is preferably one that can be blocked or released in terms of its movement with the help of the associated electric motor, as described in detail in the already referenced prior art according to DE 10 2020 102 084 A1. This means that the electric motor provided at this point actively intervenes in the function of the mass inertia element, in contrast to a passively operating mass inertia element, which cannot, for example, be blocked or influenced in terms of its movement. In addition, it is advantageous that the electric motor engages an external actuating lever in the event of a crash, thus enabling an external actuation. This safety function, known as TCR (temporary crash redundancy), can increase crash safety, in particular in conjunction with an active mass lock or the active mass inertia element. In the event of a crash, the active mass inertia element serves to block external actuation so that the lock is not accidentally unlocked or opened. However, the TCR also allows for the vehicle to be accessible from the outside again after a crash (the door or hatch can be opened using a handle). It is advantageous if the TCR function engages the external actuating lever by means of an electric motor. Particularly advantageously, this can be the case regardless of whether an anti-theft device, a central locking system or a mass/crash lock prevents external actuation.

In any case, this offers the option to control the coupling of an associated coupling lever as part of the actuating lever chain not only with the aid of the mass inertia element, but also with the aid of the electric motor as part of the active mass inertia element. Active mass inertia elements are in particular characterized by the fact that the mechanical blockability of the mass inertia element, which is possible with the help of the electric motor, allows for the associated actuating lever chain to be safely uncoupled or opened in any case. If the movement of the mass inertia element is blocked in this case, the actuating lever chain can be actuated from, for example, the outer door handle. As long as the mass inertia element remains in its initial position, the corresponding coupling lever usually remains disengaged and this does not result in a release of the locking mechanism. This definitely prevents the locking mechanism from opening.

As already explained in the introduction, the external actuating lever chain is advantageously designed to be modular. For this purpose, the external actuating lever chain can be equipped with its own lever chain housing. The lever chain housing can be detachably accommodated in the lock housing as an interchangeable insert, similar to the functional housing. In this case too, the lever chain housing is advantageously designed as a plastic injection-molded part and equipped with stops, bearing points, receptacles, etc. for the levers of the external actuating lever chain accommodated therein. In addition, the lever chain housing in question can be advantageously latched, clipped or otherwise detachably anchored in the lock housing.

The invention also relates to a method for the optional manufacture of a motor vehicle lock, as explained in more detail in claims 9 and 10. As a result, a motor vehicle lock and an associated method for its production are presented, which are characterized by a functional design and the possibility of production on one and the same production line. This can be attributed to the fact that a plurality of different embodiment variants can be realized and implemented using practically one and the same lock housing. This has not previously been thought possible in this extent and form, so that production and cost advantages can be seen overall. This is because using one and the same lock housing makes it possible to use a plurality of identical parts for the different variants, although individual variants require their own parts for their implementation. These are the main advantages.

The invention is explained in more detail below with reference to drawings showing possible exemplary embodiments. In the drawings:

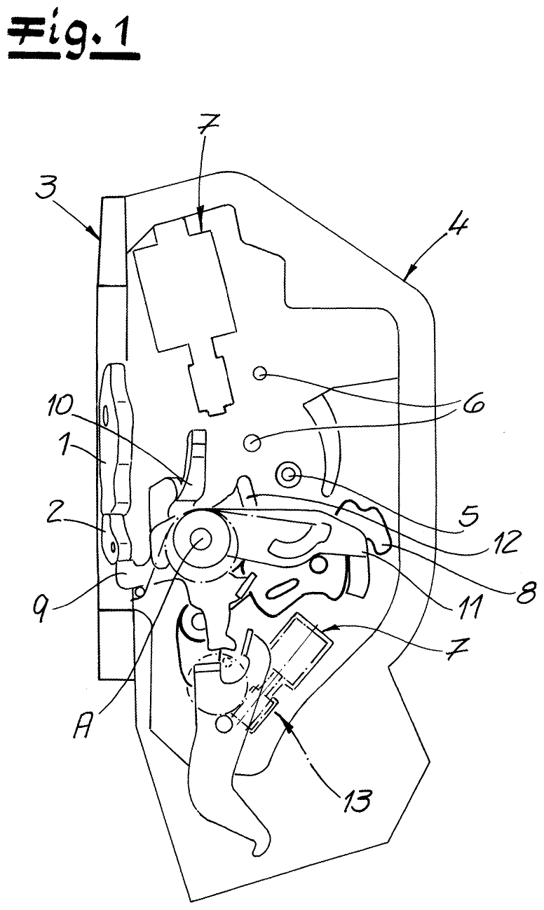

FIG. 1 shows a motor vehicle lock according to the invention having an active mass inertia element; and

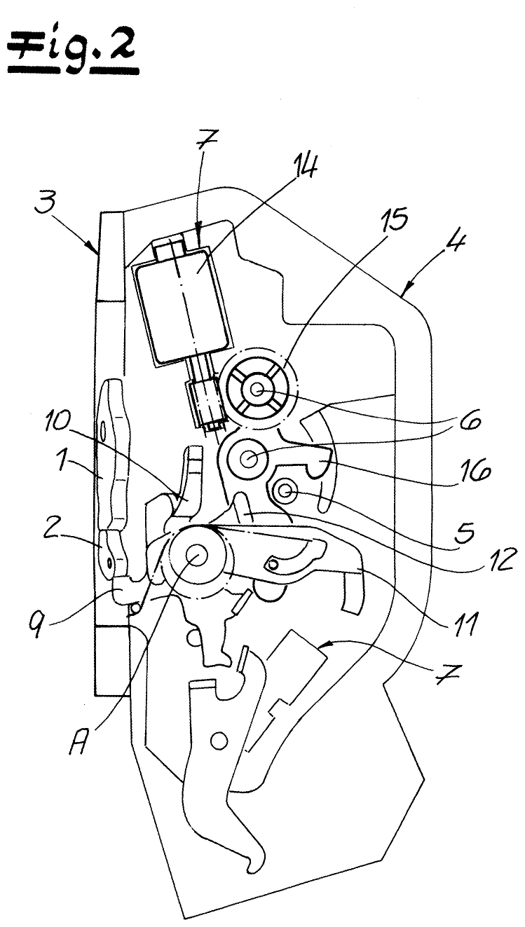

FIG. 2 shows a motor vehicle lock according to the invention having the built-in opening drive.

In the drawings, a motor vehicle lock is shown, which is a motor vehicle door lock. In its basic structure, said lock has a locking mechanism 1, 2 consisting substantially of a rotary latch 1 and a pawl 2. The rotary latch 1 and the pawl 2 are mounted in a lock case 3 for this purpose. The lock case 3 in conjunction with a cover 4 defines a lock housing 3, 4. While the lock case 3 is made of metal, for example from high-strength steel, the cover 4 is a plastic injection-molded part. As a result, the cover 4 and the lock housing 3, 4 as a whole can be equipped with stops 5, bearing points 6 and receptacles 7 which are indicated only by way of example and which are shown graphically in the figures as examples and which are only occasionally provided with reference signs. The stops 5, bearing points 6 and receptacles 7 in question are defined in the respective plastic cover 4 and thus the lock housing 3, 4, for all variants to be discussed below, as shown and reproduced in FIGS. 1 and 2. This means that the motor vehicle lock, and in particular the motor vehicle door lock, to be described in more detail below has one and the same lock housing 3, 4, regardless of the functions realized and thus the variant implemented. This facilitates manufacture and storage.

In addition, the lock housing 3, 4 is equipped with an actuating lever chain 9, 10, 11, 12 for the locking mechanism 1,2. For this purpose, the actuating lever chain 9, 10, 11, 12 has a release lever 9, a control lever 10, an internal actuating lever 11 and finally a coupling lever 12.

It can be seen that the release lever 9 and the internal actuating lever 11 are mounted on the same axis in relation to a common axis A. When the coupling lever 12 is engaged, a clockwise actuation of the internal actuation lever 11 about the axis 14 results in the internal actuation lever 11 being coupled to the release lever 9 in a rotationally fixed manner and thus in the clockwise movement being transmitted also to the release lever 9 in a clockwise direction, which can thereby lift the pawl 2 from its locking engagement with the rotary latch 1. The mentioned components inside the lock housing 3, 4, i.e., the rotary latch 1, the pawl 2, the release lever 9, the control lever 10, the internal actuating lever 11 and also the coupling lever 12 are realized in both variants according to FIGS. 1 and 2. The same applies to the stops 5, bearing points 6 and receptacles 7.

Now, in the variant according to FIG. 1, an active mass inertia element 8, 13 is additionally implemented, which is used only in this variant shown in FIG. 1 and is otherwise not reflected in the representation according to FIG. 2. The mass inertia element 8, 13 is composed of a mass inertia lever 8 and an associated electric motor 13, which is only indicated in FIG. 1 and may be accommodated in an associated receptacle 7 in the interior of the lock housing 3, 4.

The mass inertia lever 8 can be blocked or secured by means of the electric motor 13. This usually happens in the initial position of the mass inertia lever 8 as indicated in FIG. 1. If the mass inertia lever 8 is blocked in the initial position shown in FIG. 1 by means of the electric motor 13, the control lever 10 connected to the mass inertia lever 8 via a pin cannot move. This causes the coupling lever 12 to be deflected.

Blocking of the mass inertia lever 8 thus leads to a disengagement of the actuating lever chain 9, 10, 11, 12 because the coupling lever 12 is thereby deflected. This corresponds to an idle stroke of the actuating lever chain 9, 10, 11, 12, because a corresponding actuation of the internal actuating lever 12 runs, for example, idle. If, on the other hand, the mass inertia lever 8 is not blocked by means of the electric motor 13, the coupling lever 12 can engage and the actuating lever chain 9, 10, 11, 12 can thus mechanically close, so that the internal actuating lever 11 and the release lever 9 are then also coupled to one another in a rotationally fixed manner and their joint clockwise actuation about the common axis A results in the locking mechanism 1, 2 being capable of being opened as described. For this purpose, it is necessary, for example, for the mass inertia lever 8 to engage the coupling lever 12 by means of acting inertia forces in the event of a crash and to close the actuating lever chain 9, 10, 11, 12 for emergency actuation.

When comparing FIGS. 1 and 2, it becomes clear that the active mass inertia element 8, 13 is not present or installed in the variant according to FIG. 2. In contrast, the embodiment variant according to FIG. 2 has an opening drive 14, 15, 16. The opening drive 14, 15, 16 consists in detail of an electric motor 14 and an opening wheel 15 which is rotated by an output shaft of the electric motor 14. The opening wheel 15 in turn works on a transmission lever 16, which acts directly on the release lever 9 and, when appropriately acted upon, pivots the release lever 9 about its axis A in an anti-clockwise direction in order to be able to open the locking mechanism 1, 2.

According to the exemplary embodiment, the opening drive 14, 15, 16 defines a first functional unit 14, 15, 16 in accordance with the representation in FIG. 2. The active mass inertia element 8, 13 defines a second functional unit 8, 13. It can be seen that in the variant of the motor vehicle lock according to FIG. 1, the first functional unit or the opening drive 14, 15, 16 is not realized, but the active mass inertia element 8, 13 or the second functional unit 8, 13 is accommodated in the lock housing 3, 4. In contrast, the state of construction or the variant of the motor vehicle lock according to the invention is designed in accordance with the representation in FIG. 2 such that in this case the first functional unit or the opening drive 14, 15, 16 are provided in the lock housing 3, 4, whereas the second functional unit or the active mass inertia element 8, 13 is not reflected in this case. In addition to the possibility described with reference to FIGS. 1 and 2 of equipping the motor vehicle lock in question with the corresponding locking mechanism 1, 2 and the actuating lever chain 9, 10, 11, 12 in the common lock housing 3, 4 with the first functional unit as shown in FIG. 2, on the one hand, and with the second functional unit 8, 13 according to FIG. 1, on the other, there is of course also the further option of equipping both of the aforementioned functional units 14, 15; 8, 13 in the lock housing 3, 4 at the same time, or of dispensing with both entirely, although this is not shown in detail.

In any case, it can be seen that both equipment variants according to FIGS. 1 and 2 have a plurality of identical parts, namely the locking mechanism 1, 2 and the actuating lever chain 9, 10, 11, 12 in connection with the lock housing 3, 4. Only the functional units 14, 15, 16; 8, 13 are implemented differently and are present in the lock housing 3, 4. While the design variant according to FIG. 1 is equipped with the second functional unit or the mass inertia element 8, 13, the embodiment variant according to FIG. 2, on the other hand, has the first functional unit or the opening drive 14, 15, 16.

The actuating lever chain 9, 10, 11, 12 can moreover be optionally designed as an internal actuating lever chain, an external actuating lever chain or a combined internal/external actuating lever chain. According to the exemplary embodiment, the actuating lever chain 9, 10, 11, 12 is designed merely as an internal actuating lever chain 9, 10, 11, 12. An additional possible external actuating lever to be implemented can be retrofitted modularly. As a result, the external actuating lever chain realized in this way can also be designed to be modular and can optionally be placed in the lock housing 3, 4 or not.

Not shown is the possibility of the respective functional unit 14, 15, 16; 8, 13 being accommodated in its own associated functional housing. This functional housing can in turn be detachably placed in the lock housing 3, 4 as an interchangeable insert. Of course, several functional units 14, 15, 16; 8, 13 can also be used inside the functional housing (not shown), which is also not explicitly shown.

It is also possible to place the external actuating lever chain, which is modularly constructed according to the exemplary embodiment, in a separate lever chain housing, namely in the form of the external actuating lever that can additionally be mounted onto the axis A. This lever chain housing can also be detachably accommodated in the lock housing 3, 4 as an interchangeable insert. However, this is also not reflected in the exemplary embodiment.

Either way, the motor vehicle lock, and in particular the motor vehicle door lock, according to the invention can be manufactured in a particularly simple and cost-effective manner. All that is required is to equip the lock housing 3, 4, which is common to all variants, first with the locking mechanism 1, 2 and then with the corresponding actuating lever chain 9, 10, 11, 12. Depending on the equipment variant, the second functional unit or the active mass inertia element 8, 13 can then be placed inside the lock housing 3, 4, so as to obtain the embodiment variant according to FIG. 1. Alternatively, however, the first functional unit or the opening drive 14, 15, 16 can also be accommodated inside the lock housing 3, 4 when dispensing with the mass inertia element 8, 13. This results in the variant according to FIG. 2.

The options of equipping the motor vehicle lock with the first functional unit 14, 15, 16, with the second functional unit 8, 13, with both functional units 14, 15, 16; 8, 13 or without one of the two functional units 14, 15, 16; 8, 13 can be realized and implemented on one and the same production line. This is basically due to the corresponding motor vehicle lock 3, 4, which, for this purpose, is equipped with the stops 5, bearing points 6 and receptacles 7 for all variants. These are the main advantages.

### LIST OF REFERENCE SIGNS

rotary latch 1
pawl 2
locking mechanism 1, 2
lock case 3
lock housing 3, 4
cover 4
stops 5
bearing points 6
receptacles 7
mass inertia lever 8
mass inertia element 8, 13
functional unit 8, 13
release lever 9
control lever 10
internal actuating lever 11
coupling lever 12
actuating lever chain 9, 10, 11, 12
electric motor 13
axis A
electric motor 14
functional units 14, 15, 16; 8, 13
opening wheel 15
transmission lever 16
opening drive 14, 15, 16

1. A motor vehicle lock comprising:
a locking mechanism comprising a rotary latch and a pawl,
an actuating lever chain for the locking mechanism, and
at least one functional unit driven by an electric motor, wherein a respective one of the at least one the functional unit is interchangeably accommodated in an associated lock housing comprising a lock case and a cover,
wherein the at least one functional unit is designed as an opening drive and/or an active mass inertia element.

2. The motor vehicle lock according to claim 1, wherein the actuating lever chain is designed as an external actuating lever chain.

3. The motor vehicle lock according to claim 2, wherein the external actuating lever chain is designed to be modular and is accommodated in the lock housing.

4. The motor vehicle lock according to claim 1, wherein the associated lock housing is equipped with stops, bearing points, and receptacles-etc. for all variants.

5. The motor vehicle lock according to claim 1, wherein the respective one of the at least one functional unit is equipped with a functional unit housing, wherein the functional housing is detachably accommodated in the associated lock housing as an interchangeable insert.

6. The motor vehicle lock according to claim 5, wherein the functional unit housing is equipped with stops, bearing points, and receptacles for the respective one of the at least one functional unit accommodated therein.

7. The motor vehicle lock according to claim 5, wherein the functional unit housing is detachably accommodated in the lock housing.

8. The motor vehicle lock according to claim 3, wherein the external actuating lever chain is equipped with a lever chain housing, wherein the lever chain housing is detachably accommodated in the lock housing as an interchangeable insert and the lever chain housing is equipped with stops, bearing points, and receptacles for the external actuating lever chain accommodated in the lever chain housing.

9. A method for manufacturing a motor vehicle lock wherein the motor vehicle lock has a locking mechanism comprising a rotary latch and a pawl, an actuating lever chain for the locking mechanism, and at least one functional unit driven by an electric motor, the method comprising the steps of:
interchangeably accommodating a respective one of the at least one functional unit in an associated lock housing,
wherein the at least one functional unit is designed as an opening drive and/or active mass inertia element.

10. The method according to claim 9, wherein during manufacture the associated lock housing is equipped with stops, bearing points, and receptacles by a plastic injection molding process.

11. The motor vehicle lock according to claim 1, wherein the actuating lever chain is designed as an internal actuating lever chain.

12. The motor vehicle lock according to claim 1, wherein the actuating lever chain is designed as a combined internal/external actuating lever chain.

13. The motor vehicle lock according to claim 5, wherein the functional housing is designed as a plastic injection-molded part.

14. The motor vehicle lock according to claim 8, wherein the lever chain housing is designed as a plastic injection-molded part.

15. The motor vehicle lock according to claim 1, wherein the actuating lever chain comprises a release lever, a control lever, an internal actuating lever, and a coupling lever.
